(19) United States
(12) Patent Application Publication
(10) Pub. No.: US 2021/0139714 A1
(43) Pub. Date: May 13, 2021

(54) MULTI-FUNCTIONAL DISPERSANT FOR CHEMICAL COATING COMPOSITIONS

(71) Applicant: PISON STREAM SOLUTIONS INC., New York, NY (US)

(72) Inventors: Joseph H. James, New York, NY (US); Sanjana Das, New York, NY (US); Subadhra Stoll, Brecksville, OH (US)

(21) Appl. No.: 16/681,022

(22) Filed: Nov. 12, 2019

(51) Int. Cl. C09D 5/03; C09D 167/00

(52) U.S. Cl. CPC C09D 5/037; C09D 167/00; C09D 5/031

(57) ABSTRACT

A multi-functional dispersant that also serves as a flow modifier and rheology modifier is contemplated. The dispersant itself is a mixture, extruded in the presence of water so as to impart moisture to that extrudate, which is formed from polyester resin, curatives, anti-corrosion pigments, UV absorbers, catalysts, flow modifiers, degassers, anti-oxidants and glass flakes. After grinding and optional mixing with a silica carrier, the resulting dispersant may be introduced to solid and liquid (by way of water) finished coating compositions in order to improve various properties of the coating.

### FIELD AND BACKGROUND OF INVENTION

The invention relates to additives for chemical coating compositions and, more specifically to a dispersant provided as a discrete, holistic powder composition that can be incorporated into powder and liquid coating formulations.

Powder coating compositions are dry, free-flowing powders. In use, these powders are applied to a substrate (e.g., electrostatic spraying, fluidized bed coating, and/or hot flocking), which is then heated. This added energy causes the powder to melt, flow, and fuse into a continuous film. Advantageously, this procedure results in a robust film with good adhesion, while effectively eliminating the need to rely upon solvents (and particularly volatile organic compounds).

Generally speaking, powder compositions are primarily composed of polyurethanes, polyester, polyethylene, and epoxy, as well as various combinations thereof (e.g., epoxy-polyester, urethane-polyester, etc.), as base resin(s). Polyisocyanates, tryglycidylisocyanurate (TGIC) and TGIC-free curatives may be included, and other additives, such as flow control agents, hardeners, catalysts, fillers, gloss control agents, pigments, and charge inhibitors may also be incorporated to enhance the characteristics of the blend as it is mixed, applied, and/or fused. In operation, the resins melt and fuse together, while the additives facilitate various underlying attributes during or after fusion, all with the goal of creating a chemically non-reactive, durable, and continuous coating wherever the composition is applied to the substrate. In some instances, the formulation may be created to allow the composition to be used as a solid, dry powder or, by suspending or otherwise mixing that powder with a liquid carrier, in a liquid form.

Conventional formulations often rely on additives to impart a specific function to the coating composition, such as wetting, flow characteristics (e.g., viscosity, etc.), surface hardness, or other traits. In these prior art compositions, a separate coating additive was required to impart just one of these functions, with the additive usually becoming effective upon curing within the composition during application. Prior to the invention disclosed below, multi-functional additives (i.e., one additive that was able to deliver several different characteristics/functions) were not believed to be feasible.

Because the base resins create the bulk of final chemical coatings (whether powder or liquid), it is generally thought to be desirable to maximize the amount of resin. In contrast, and especially to the extent that additives typically cost more and/or present unique formulation challenges in comparison to the base resins, additives tend to be used in their purest possible form but at the lowest possible levels while still delivering the desired attributes.

Two problems that arise during the fusion or curing of a coating are the instability of the pigments and fillers and formation of surface defects. Uneven dispersion of the composition (e.g., how the pigments are mixed and distributed through the larger system of base resins and the like) can disrupt the distribution of solid particles in liquid media and shorten stability of the system. Formation of surface defects, on the other hand, can create irregularities which affect the flow of the fusing materials, thereby resulting in “orange peel” (i.e., non-smooth appearance or finish after the composition solidifies).

It is thought that minimizing surface tension should improve wetting/dispersing and, by extension, improve flow characteristics. One approach is to rely on dispersants, such as homopolymers and copolymers of polyacrylates (e.g., esters of methacrylic and acrylic acids). Such additives can be provided in a master batch dispersed on silica particles at an active level of up to 65 wt. % in the additive (or about 1.0 wt. % of the total composition), although additional additives may be required (e.g., Resiflow P-64F (Estron Chemical), Resiflow PH-240 (Estron Chemical), Modaflow AQ3025 (Allnex), DISPERBYK-2205 (BYK) which are all dispersants).

Other approaches include increasing extruder temperature and mix times and increasing the amount of additives. Absent the use of specific additives, the most prevalent means to address this defect is to increase or decrease the film build or thickness.

Unfortunately, some of these non-additive solutions are not satisfactory because they result in another undesired side effect known as “edge pulling.” Edge pulling is a condition in which the coating pulls away from the corners of the coated substrate resulting in incomplete formation of the finish.

The conventional additive solutions described above add cost owing to their reliance on various additional substances. Further, these additives may not be compatible with all coating platforms, and properly incorporating or introducing the additive into the formulation can present its own challenges. For example, the additive must provide an acceptable performance on the Hegman-type gage tests (e.g., ASTM D1210), which measures the fineness of dispersion of pigment vehicle systems, in order to be incorporated into liquid-based platforms.

Another issue with respect to existing additives, and particularly dispersants, is that they generally serve only one purpose—to address the aforementioned issues with respect to stabilization of pigments and uneven distribution. Thus, the mass/volume dedicated within the overall composition to this single issue means lost opportunities to maximize the formulation in other respects.

Ultimately, the presence of surface defects and an uneven distribution of coating on the system often results in rejection of the coated article. In turn, these rejections result in the discarding of the coated articles and/or the costly reworking of the articles.

In view of the foregoing, a cost effective dispersant would be welcome. Further, a dispersant that serves multiple purposes—including some of the other additive functions identified above—would be particularly helpful, especially to the extent such an agent could be used in either powder or liquid forms.

### SUMMARY OF INVENTION

A multi-functional dispersant that also serves as a flow modifier and rheology modifier is contemplated. The dispersant itself is a mixture, extruded in the presence of water so as to impart moisture in the final extrudate. That extrudate is formed from polyester resin, curatives, anti-corrosion pigments, UV absorbers, catalysts, flow modifiers, degassers, anti-oxidants and glass flakes. The resulting dispersant may be introduced to solid and liquid (by way of water) finished coating compositions at about 0.5 to 1.5 wt. % of the total composition. In some embodiments, the dispersant may be introduced to the conventional coating platform by way of (3-aminopropyl) trimethoxysilane (TMS) and/or other silica carriers (e.g., silicon dioxide at 45 to 55% active levels).

While the dispersant additive in its final form appears as if it could serve as a powder coating composition in its own right, the inventors have discovered that the formulation can be used as an additive in a wide range of different coating platforms without the need for other dispersants. Further, the dispersant itself is not formulated to be—and, in numerous embodiments, simply cannot serve as—a distinct, stand-alone coating composition. For example, a preferred curative combination provided to the dispersant is not capable of adequately curing or hardening the resins of the dispersant.

One aspect contemplates a powder composition consisting of the aforementioned dispersant provided at between 0.5 and 1.5 wt. % and a finished powder coating, provided as the balance, having resins other than those identified as part of the multi-functional dispersant. Multiple resins and/or other optional additives, including hardeners, tetramethoxy glycoluril, pigments, waxes, catalyst, flow aids, degassing agents and gloss modifiers may be included in the additive.

Further reference is made to the appended claims and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DETAILED DESCRIPTION

Reference will now be made in detail to exemplary embodiments of the present invention. It is to be understood that other embodiments may be utilized, and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Any elements described herein as singular can be pluralized (i.e., anything described as “one” can be more than one). Any species element of a genus element can have the characteristics or elements of any other species element of that genus. The described configurations, elements or complete assemblies and methods and their elements for carrying out the invention, and variations of aspects of the invention can be combined and modified with each other in any combination. As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As noted above, the inventors endeavored to create a multi-functional dispersant which could simultaneously address the issues of uneven distribution of final coating and instability of pigments and surface defects, while also delivering other benefits to the powder and/or liquid coating compositions. These added benefits could include lower viscosity during the fusion process, improved surface tension, higher chemical resistance, improved substrate wetting and increased flow in surface rheology, increased stability of fillers and pigments therefore even dispersion of final fused/cured coating.

The dispersant disclosed herein is particularly advantageous because in addition to being effective as a multifunctional dispersant it can be effective as a flow modifier and increasing surface rheology while improving surface tension. It has now been discovered that a combination of polyester resin, and spherical glass flakes blended in conjunction with additional constituents provided as a liquid precursor component during the manufacture of the dispersant. That liquid precursor includes polymeric curatives, catalysts, flow modifiers, anti-oxidants, degassing agents, UV inhibitors, anti-corrosion pigments that are blended. Once blended and mixed, approximately 30 wt. % of water, preferably de-ionized and/or distilled, is added to the dried constituents of the dispersant composition (relative to the total weight of all constituents of the dispersant, inclusive of water). The presence of this liquid is believed to increase wetting during manufacture of the dispersant, as well as the subsequent use of the dispersant, by adding moisture during the extrusion process.

This mixture of solid and liquid is then extruded, although it is noteworthy that the introduction of (3-aminoproply) trimethoxysilane and silica type carriers such as silicone dioxide at (45-55% active) after extrusion and grinding of the liquid precursor may reduce orange peel significantly. The silica carrier is used in an amount of about 0.5 to 5.0% by weight based the balance of the dried/extruded dispersant composition being 100% as shown in the tables below.

In one embodiment the dispersant is introduced to platform coating systems in an amount of about 0.5%-1.5%. In this implementation of the invention, conventional flow and leveling agents or additives such as modified polyacrylates are not necessary. For example, dispersants such as polyacrylates are polymers or co-polymers of esters of methacrylic and acrylic acids, flows aids and leveling agents such as Resiflow P-67 (Estron Chemical), Resiflow P-1200 (Estron Chemical), Resiflow P-65, (Estron Chemical), Oxymelt A-2 (Estron Chemical), Modaflow 2000 (Allnex), and X-22 from (Monsanto) are not required.

Representative examples of polyester hydroxyl resin useful in one embodiment include: Crylcoat 2401-2 and Crylcoat 2471-4 (from Allnex); SP-100 and SP-400 (from Sun Polymers); and Rucote 102, 108, and Rucote 121 (from Stepan Company).

Representative curatives useful in one embodiment include, Crelan NI2 blocked cycloaliphatic polyisocynate, Dow Chemical TGIC, (triglycidyllisocyanurate), Epikure 101 Imidazole Adduct, Epikure P-108 DICY Imidazole Adduct, aliphatic and cycloaliphatic amine curing agent from Momentive Industries and phenolic hardener DEH84 from Dow Chemical.

While not necessary to the underlying efficacy of the dispersant, it may also be possible to include anywhere from 0.3 to 0.8 wt. % (of the total dispersant composition) of one or more flow aids, such as PF45 sold by Pison Stream Solutions Inc. Additional or alternative aids of this nature are disclosed in U.S. Pat. No. 9,353,254, (incorporated by reference herein), which describes a powder coating flow aid relying on a polyethylene resin combined with a polyester hydroxyl resin. A polymeric curative, degassing agent, ricinoleic acid (i.e., 12-hydroxy-9-cis-octadecenoic acid), and glass flake are also used, and the flow aid is introduced to powder coating compositions by way of a silica carrier. The polyethylene is provided at between 3.1 to 9.5 wt. %, the polyester hydroxyl at 35 to 50 wt. %, the polymeric curative at 5.0 to 10 wt. %, the degassing agent at 0.25 to 2.0 wt. %, the ricinoleic acid at 0.5 to 3.0 wt. %, glass flakes at 20 to 50 wt. %, and the silica carrier being 0.5 to 5.0 wt. % of the flow aid's total weight.

One of the advantages of the dispersant, at least in comparison to other coating additives and leveling agents, is that it may be inserted directly into a smooth texture coating platform binder system such as polyurethane, hybrid, TGIC, and Primid™ systems (manufacturers include EMS, Sun Polymer, Dow Industries, and Kukdo (Seoul, South Korea)). For epoxy system platforms Kukdo Epoxy Resins KD-211E, KD-211G, KD-242G, KD-243C and Dow's D.E.R 633U and Vantico GT7013 epoxy resin can be added at about 0.5% up to about 4.0% by weight of total binder. In addition, this dispersant can also be post added/blended at about 0.03% up to about 0.9% by weight to act as an extender to the current dispersant in formulation.

The dispersant can be added to liquid as well as powder formulations. The formulation may be combined with liquids such as water (preferably de-ionized and/or distilled), acetone, methyl-ethyl ketone (butanone), ethanol, and other, similar common industrial solvents, as well as combinations thereof. When the dispersant is combined with such a liquid carrier, the formulation volatilizes after the initial coating.

Typically, about 0.5% to about 1.5% by weight of a finished powder coating platform will be comprised of the dispersant. Unless otherwise stated, all percentages stated herein are weight percentages based on the total powder coating composition or, in the context of the dispersant component itself, the composition of the additive/agent.

Coating platforms containing the dispersant are preferably added to a conventional thermosetting powder coating resin material. The material is selected from one or more of the groups of epoxy, epoxy-polyester, hydroxyl polyester, acrylic, TGIC polyester and TGIC-free polyester resins. Conventional additives, such as hardeners, tetramethoxy glycoluril, pigments, waxes, catalysts, flow aids, degassing agents and gloss modifiers may be included, although many of these additives will be unnecessary in view of the dispersant's capabilities.

Representative and suitable epoxy resins include Kukdo Epoxy resin KD-242H. KD-242H is a bisphenol-A type solid epoxy resin which has excellent flow characteristics. KD-242H has an epoxy equivalent weight specification of 660-720 (g/eq), a softening point of about 85 to 95° C., and a melt viscosity of specification of about 2200 to 2800 cps at 150° C. Suitable hardeners include Kukdo KD-410J, Epikure 101 and Dyhard 100.

Dow Chemical's D.E.R 663U is a solid epoxy resin and is a standard medium molecular weight epoxy resin for powder coating applications. The resin has an epoxy equivalent weight specification of 730-820 (g/eg), a softening point specification of 92-102 C. and a melt viscosity specification of 2000-4000 cps at 150° C. Suitable hardeners include Kukdo KD-401, KD-41, KD-410J, Epikure 101 and Dyhard 100.

Representative examples of epoxy-polyester resins useful in one embodiment include: Crylcoat 2401-2, Crylcoat 2471-4 from Allnex; SP-100 and SP-400 from Sun Polymers; and Rucote 102, 106, and Rucote 118 from Stepan Company. The table below shows one example of a dispersant formulation in accordance with one embodiment of the invention (column 2) and approximated weight ranges covering other embodiments of the invention.

TABLE 1
Liquid precursor for making dispersant useful in finished coating compositions.

| Exemplary | Min/max | | |
|---|---|---|---|
| Weight (g) | range, wt. % | Component | Examples and notes |
| 300 | 25.0-35.0 | Water | H₂O (preferably de-ionized and/or distilled) |
| 585 | 50.1-66.9 | Polyester Resin | TGIC Polyester with a viscosity of 50-64 ps @ 200° C., |
| | | | with a T_{g} of 62° C. to 68° C. |
| 41.2 | 3.53-4.71 | Curative(s) | TGIC (triglycidyllisocyanurate), Blocked |
| | | | cycloaliphatic polyisocyanate, and blocked |
| | | | aliphatic and aromatic polyisocyanate |
| | | | curatives |
| 0.8 | 0.06-0.08 | Anti-corrosion | Basic Zinc Phosphate, such as with a |
| | | agent(s) | density of 3.0-4.0 g/ml, a pH of 6.7-7.2 and |
| | | | an oil absorption of 20-25 cm3/g |
| 3.7 | 0.32-0.42 | UV Absorber(s) | Includes triazine based UV Stabilizer with a |
| | | | molecular weight of 583 g/mol and a |
| | | | melting range of 70° C.-80° C. |
| 1.5. | 0.13-0.17 | Catalyst(s) | 2 Methyl-Imidazole Catalysts |
| 3.78 | 0.32-0.42 | Flow modifier(s) | Contains polyethylene and polyester |
| | | | hydroxyl resins, along with curative, |
| | | | degasser, ricinoleic acid, and glass flake, on |
| | | | a silica carrier; see U.S. Pat. No. |
| | | | 9,353,254 (incorporated by reference) |
| 22.1 | 1.90-2.52 | Glass flake(s) | Corrosion resistant glass flake; particle size |
| | | | distribution between 1700 μm-150 μm |
| | | | (80% or more) |
| 14.8 | 1.26-1.68 | Anti-oxidant agent(s) | Phenolic antioxidant with a density of 1.15 |
| | | | g/ml @ 20° C. and a melting range of 105- |
| | | | 130° C. |
| 27.2 | 2.33-3.11 | Degassing agent(s) | Nonionic surfactant with a viscosity of 15- |
| | | | 20 mPas @ 55° C. with a freeze point of 53- |
| | | | 56° C. |

Processing notes: At ambient temperature and pressure, components above are admixed in a tumbler for 40-55 minutes or in a high-speed mixer for 45-50 seconds until fully blended. Once blended, 30% of water (preferably de-ionized and/or distilled) is added to this blended dry formulation. The blend of powder and liquid material is then placed in the extruder hopper via the screw mechanism at 300 RPM to the extruder dye, preferably with three temperature zones at a feed rate of 400 g/min. The zone settings may be, respectively 60/60/100° C. The extrusion sheet product is then ground into particles (e.g., via a Retch mill grinder or coffee grinder) for 1-5 minutes at ambient temperature and pressure to form a powder having most or substantially all of the particles preferably between about 30 to 50 μm in size.

The formulations contemplated by Table 1 encompass any combination of values selected from each of the stated ranges. Any of these combinations can be extruded, ground to an optimized particle size (e.g., 100 nanometers to 5 micrometers), and adhered to a silica carrier such as (3-aminopropyl) trimethoxysilane and/or a silicone dioxide-precipitated amorphous silicate (45-55% active).

In one embodiment, the dispersant may be prepared by admixing the polyester resin, curative, anti-corrosion pigment, UV absorber, catalyst, flow modifier, anti-oxidant agent, degassing agent, spherical flake and other components. The components are admixed either in a tumbler for 40-55 minutes or with a MIXACO™ high speed mixer used for blending raw material constituents for 45-50 seconds at ambient temperature and pressure or until such components are fully blended. Once blended, approximately 30% of water (preferably de-ionized and/or distilled) is added to the composition. This final admixture is then extruded to distribute the constituents and form an extrusion product. The liquid partially evaporates causing a partial vapor to occur when the saturated liquid stream undergoes a reduction in pressure by passing through the extruder—this adds moisture to the composition. Any suitable extruder utilizing a single or twin-screw mechanism may be used to form an extrusion product. The blended material is placed in the extruder hopper and fed via the screw mechanism to the extruder dye, preferably with three temperature zones. The zone settings may be, respectively, 60/60/100° C. The blended constituents are extruded at 300 RPM and at a feed rate of 400 g/min to form an extrusion product.

The extrusion sheet product is then ground into particles with a suitable grinding machine such as a Retch mill grinder or coffee grinder. The extrusion product is ground for about 1-5 minutes at ambient temperature and pressure to form a powder having a typical particle size between about 30 to 50 μm. A Henschel high-speed system is used to blend the powder for micronizing.

After grinding, this material can be used as desired to replace current dispersants. For example, this material can be used to replace Resiflow P-64F, Resiflow PH-240 or Modaflow AQ3025. This product can also be post added at the percentages described above in the Summary section.

Notably, the extrudate that forms the dispersant composition is chemically distinct from the remaining components provided as part of the larger finished coating composition. That is, the distinct dry powder/particulate constituents blended the finished coating composition are each of a different chemical composition in comparison to the extrudate that serves as the dispersant. As an example, the final, extruded particles of the dispersant may include polyester along with acrylic, glass flakes, and other residual constituents produced by extrusion of the dispersant composition (including water/moisture), whereas each item blended into the finished composition is a separately and individually provided resin (e.g., polyester, acrylic, and/or other constituents) or additive. Of course, after the dispersant and finished coating composition are applied and cured, further reactions may occur, but at the moment the dispersant component is blended with the finished coating composition components, each finished coating composition is chemically distinct form the dispersant composition.

In a first embodiment, a coating composition having any combination of the following elements is contemplated:
a dispersant component extruded from a blend of materials consisting essentially of: 50.1 to 66.9 wt. % TGIC polyester resin, 3.53 to 4.71 wt. % curative, 0.06 to 0.08 wt. % anti-corrosion pigment, 0.06 to 0.08 wt. % UV absorber, 0.13 to 0.17 wt. % catalyst, 0.32 to 0.42 wt. % of flow modifier, 1.26 to 1.68 wt. % antioxidant, 2.33 to 3.11 wt. % degassing agent, 1.90 to 2.52 wt. % of glass flakes, and 25.0 to 35.0 wt. % of deionized and/or distilled water.
wherein the dispersant component is 0.06 to 1.50 wt. % of the total composition with the finished coating resin(s) and optional finished coating additives, all of which are chemically distinct from the dispersant component and, collectively, provided as a remainder of the total composition;

In a separate embodiment, a multi-functional dispersant additive for use in a coating composition having any combination of the following elements is contemplated:
50.1 to 66.9 wt. % TGIC polyester resin;
3.53 to 4.71 wt. % curative;
0.06 to 0.08 wt. % anti-corrosion pigment;
0.06 to 0.08 wt. % UV absorber;
0.13 to 0.17 wt. % catalyst;
0.32 to 0.42 wt. % of flow modifier;
1.26 to 1.68 wt. % antioxidant;
2.33 to 3.11 wt. % degassing agent;
1.90 to 2.52 wt. % of glass flakes;
and 25.0 to 35.0 wt. % of deionized and/or distilled water.
wherein the dispersant is composed of the above constituents 70% in powder form and 30% in liquid form;
wherein the dispersant component is provided on a silica carrier;
wherein a ratio of silica carrier to dispersant component is provided at between 9:11 and 3:7;
wherein the silica carrier is selected from (3-aminopropyl) trimethoxysilane, silicon dioxide, and combinations thereof;
wherein the dispersant component is provided as particles each having a size of less than 5 micrometers;
wherein the particles each have a size of greater than 100 nanometers; and

In a further embodiment, a coating composition includes any combination of the following:
at least one finished coating component provided at a weight ratio of 98 parts or more of the finished coating component and between 0.05 to 2 parts of either the additive or the coating composition described in the preceding paragraphs; wherein the finished coating component includes a thermosetting resin and at least one additive selected from: 12-hydroxy-9-cis-octadecenoic acid, glass flakes, tetramethoxy glycoluril, pigments, waxes, hardening catalysts, and any combination of two or more thereof;
wherein the finished coating component forms a fusion powder coating film when the composition is cured; and
wherein the finished coating component includes a resin and a liquid carrier that is removed from a final, coating film when the composition is cured.

In a still further embodiment, a powdered dispersant component for use in chemical coating compositions consists of any combination of the following features:
an extrudate formed in the presence of water, said extrudate consisting essentially of between 79.3 and 87.2 wt. % triglycidyl isocyanurate (TGIC) polyester, 4.48 to 7.70 wt. % of a polyisocyanate curative, 2.39 to 4.16 wt. % of glass flakes, and a remainder of constituents including at least one of: an anti-corrosion pigment, a UV absorber, a catalyst, a flow modifier, an anti-oxidant, and a degassing agent and wherein all aforementioned wt. % exclude any moisture retained in the extrudate after formation;
wherein the remainder of constituents consists essentially of 0.08 to 0.13 wt. % anti-corrosion pigment, 0.40 to 0.70 wt. % UV absorber, 0.16 to 0.28 wt. % catalyst, 0.40 to 0.70 wt. % of flow modifier, 1.58 to 2.78 wt. % antioxidant, 2.94 to 5.12 wt. % degassing agent and wherein all aforementioned wt. % exclude any moisture retained in the extrudate after formation;
wherein, by weight, approximately 1 part of water is provided to between 1.85 to 3.00 parts of extrudate during formation of the extrudate and wherein moisture is retained in the extrudate after formation;
wherein, after formation and grinding of the extrudate into particles, the dispersant component is provided on a silica carrier;
wherein a ratio of silica carrier to dispersant component is provided at between 9:11 and 3:7;
wherein the silica carrier is selected from (3-aminopropyl) trimethoxysilane, silicon dioxide, and combinations thereof;
wherein the extrudate is provided as particles each having a size of less than 5 micrometers; and
wherein substantially all of the particles are greater than 100 nanometers.

Additionally, finished chemical coating compositions for application to and curing upon a substrate or article are contemplated. These compositions include any iteration of the dispersant compositions identified above/herein along with any combination of the following features:
a finished coating composition comprising one or more resins and optional additives, wherein each of the one or more resins are chemically distinct from the extrudate and wherein the finished coating composition comprises at least 90% of the total weight of the chemical coating composition;
wherein the dispersant component is 0.06 to 1.50 wt. % of the total composition with the finished coating resin(s) and optional finished coating additives provided as remainder;
wherein the optional additives are present and include at least one additive selected from: 12-hydroxy-9-cis-octadecenoic acid, glass flakes, tetramethoxy glycoluril, pigments, waxes, hardening catalysts, and any combination of two or more thereof;
wherein the finished coating composition is provided as particles each being greater than 20 micrometers in diameter;
wherein the finished coating composition is provided as particles each being less than 40 micrometers in diameter;
wherein the resin(s) of the finished coating composition include a thermosetting resin;
wherein the thermosetting resin is selected from the group consisting of epoxy resin, epoxy-polyester resin, acrylic resin, hydroxyl polyester resin, TGIC polyester, TGIC-free polyester resin, acrylic resin and any combination of two or more thereof;
wherein the thermosetting resin includes a TGIC polyester resin; and
wherein the finished coating composition forms a fusion powder coating film when cured.

Various processes for making the aforementioned coating compositions include any combination of the following elements:
by admixing the polyester resin, curative, anti-corrosion agent, UV absorber, catalyst, flow modifier, anti-oxidant agent, degassing agent and glass flakes first by mixing/grinding and blended in the presence of water;
then preparing a separate solid/powder mixture of polyester resin, curative, anti-corrosion agent, UV absorber, catalyst, flow modifier, anti-oxidant agent, degassing agent;
mixing both components and the at least one finished coating resin(s) to form a mixture;
extruding the mixture to produce a coating extrudate;
grinding the coating extrudate to a predetermined particle size range to produce the fusion dispersant additive composition;
mixing a silica carrier with the dispersant extrudate to form the dispersant component;
prior to the mixing, grinding the dispersant extrudate to an optimized particle size range;
wherein a weight ratio of silica carrier to dispersant extrudate is between 45:55 and 35:65; wherein the optimized particle size range is between 100 nanometers and 5 micrometers; and
wherein the optimized particle size range is between 20 and 30 micrometers.

Another process of making a dispersant additive for use in finished chemical coating compositions is contemplated. This process includes any combination of the following features:
preparing a liquid precursor by admixing dried constituents to create an admixture, the dried constituents including greater than 75 wt. % (relative to the directed constituents) of triglycidyl isocyanurate (TGIC) polyester resin and a remainder including a polyisocyanate curative, glass flakes, and at least one or more selected from: an anti-corrosion pigment, a UV absorber, a catalyst, a flow modifier, an anti-oxidant, and a degassing agent, and mixing water with the admixture at a ratio of at least 1 part by weight of water to 3 parts by weight or less of admixture to create an extrusion mixture;
extruding the extrusion mixture to produce a dispersant extrudate;
grinding the dispersant extrudate to a predetermined particle size range to produce the dispersant additive;
wherein the dispersant extrudate includes moisture imparted from the mixing of water with the admixture
wherein the water is distilled and/or deionized water
wherein the ratio is 1 part of water to between 1.85 and 3.00 parts of admixture;
after extruding and grinding, mixing a silica carrier to form the dispersant additive;
wherein the predetermined particle sizes all fall between 100 nanometers and 5 micrometers in diameter;
wherein the admixture consists essentially of between 79.3 and 87.2 wt. % triglycidyl isocyanurate (TGIC) polyester, 4.48 to 7.70 wt. % of a polyisocyanate curative, 2.39 to 4.16 wt. % of glass flakes, and a remainder of constituents including at least one of: an anti-corrosion pigment, a UV absorber, a catalyst, a flow modifier, an anti-oxidant, and a degassing agent and wherein all aforementioned wt. % exclude any moisture retained in the extrudate after formation; and
wherein the remainder consists essentially of 4.48 to 7.70 wt. % of a polyisocyanate curative, 2.39 to 4.16 wt. % of glass flakes, 0.08 to 0.13 wt. % anti-corrosion pigment, 0.40 to 0.70 wt. % UV absorber, 0.16 to 0.28 wt. % catalyst, 0.40 to 0.70 wt. % of flow modifier, 1.58 to 2.78 wt. % antioxidant, and 2.94 to 5.12 wt. % degassing agent.

In yet another embodiment, a method for improving the surface tension, avoiding uneven distribution of coating on the system and or/irregularities in cured powder coatings—can include any combination of the following:
providing a dispersant composition to silica carrier to create an additive component;
providing the additive component to a chemical coating base comprising at least one finishing resin to create a finished coating composition, wherein the additive component is provided at less than 1.5 wt. % of the finished coating composition;
applying and curing the finished coating composition on a substrate;
wherein between one to two times more dispersant is provided, by weight, than silica carrier when creating the additive component;
wherein all of the additive resin components are chemically distinct from the finishing resin(s); and
wherein the dispersant composition is subjected to grinding until a particle size of between 100 nanometers and 5 micrometers is achieved before the dispersant is provided to the silica carrier.

The dispersant as disclosed herein delivers the following advantages in comparison to finished chemical coating compositions:
Reduced or mitigated surface defects, improves substrate wetting, making the overall powder and liquid binder system more effective;
Enhanced wetting by reducing surface tension of liquids;
Reduces hiding of coating and avoids bleeding of color;
Improved surface tension in powder and liquid coating system platforms formed by coating compositions and constituents by aiding with creating a lower viscosity during endothermic reaction period;
Increased flow during the endothermic reaction at an increase rate, allowing for a smooth surface after solidification;
Improved surface by eliminating surface defects such as pinholes, orange peels and craters;
Improved wetting and adhesion on hydrophilic substrates;
Chemical resistance to a host of reagents such as acetic acid, sulfuric acid, hydrochloric acid and acetic anhydride corrosive acids and bases such as sodium hydroxide (NaOH) and potassium hydroxide (KOH)—all of which may be key reagents used for obtaining certification of conventional finished coating platforms.

Further, it should be noted that while the dispersant disclosed herein nominally includes components that are common to conventional powder coatings, the ancillary components (i.e., the non-resin components, such as anti-corrosion pigments, curative/hardeners, degassing agents, anti-oxidants, and the like) are not necessarily selected so as to make the dispersant a viable, stand-alone finished coating composition in its own right.

Instead, the dispersant is specifically formulated as a powder additive to integrate with conventional finished chemical coating compositions so as to improve surface tension, stabilize pigments, increase flow, etc. as such finished coating compositions (including the inventive additive) are cured. This holistic approach to formulating an additive—by considering a combination of resins and ancillary components that deliver a synergistic effect—is, in the inventors' view, a stark departure from previous dispersants and other additives. Whereas legacy commercial additives have identified one or two chemicals as “active” or important contributors to the dispersant's efficacy—with the additive itself then formulated to maximize the amount(s) of those active ingredients—the disclosed aspects of this invention acknowledge the significance of providing an entire binder system that itself melts and integrates with finished coating composition to which it is added and, eventually, cured.

Further, by relying on a silica carrier, the inventive dispersant can be integrated seamlessly during the curing process. That is, the micronized dispersant (i.e., particle sizes between 100 nanometers and 5 microns) can be introduced to the finished coating composition by way of an inert carrier that will simply become part of the final, cured coating. Further, by associating the dispersant with the silica carrier, storage and handling of the additive/agent is simplified.

One aspect of the disclosed formulations is that the amounts of each dispersant component are selected relative to ratio of additive to silica carrier. That is, the dispersant additive adheres to the silica carrier in known amounts, so that the combination additive-carrier is provided to the finished coating composition at the relatively low weight percentages contemplated herein. Further, given the aforementioned synergistic effects of the constituents of the additive, the relative (or “stoichiometric”) amounts of the constituents and silica carrier are important to the efficacy of the final additive.

The dispersant platform contemplated herein can be cured 10 min. @ 375° F. or 20 min. @ 350° F., using a convection oven such as laboratory oven (e.g., Blue M made in White Deer Pa.). The additive is then milled or ground to a particle size that is appropriate for powder coating applications, with micronized sizes being most ideal when a silica carrier is used. In this manner, as little as 0.5 to 15 grams of dispersant per 1000 grams of finished coating powder can be effective when blending a finished powder coating composition, post extrusion (of the finished coating composition), according to certain aspects of the invention. Alternatively, as noted above, 0.5 to 1.5 wt. % of the dispersant can be blended and extruded with/as part of the finished coating composition.

In identifying appropriate resins for the dispersant (i.e., the TGIC polyester resin), alternatives can be identified so long as they have the same chemical composition and similar characteristics—such as the viscosity, T_{g} temperature, and/or differential scanning calorimetry—as the exemplary grades of material identified herein.

Further, coating compositions having the multi-functional dispersant can be applied on various substrate types such as plastic, metal, aluminum, wood, concrete, paper, cloth, stucco and a host of other materials to act as a coating. Additional, exemplary resins and additives, suitable for such coating compositions, as disclosed in any the references identified herein are also incorporated by reference. Still other components may be mixed into or formed as part of the extruded powder.

Unless specifically noted, all tests and measurements are conducted in ambient conditions according to commonly accepted measurement protocols (e.g., such as those regularly published by ASTM International) and relying upon commercially available instruments according to the manufacturer-recommended operating procedures and conditions. Specific tests and regimens identified in the military specifications noted above may be particularly informative, including ASTM E308, E1331, D3723, D476 (type III or IV), D3335, D3271, D2805, D1849, D7734, D4242, D3359, G154, G90, and B117. Unless noted to the contrary (explicitly or within the context of a given disclosure), all measurements are in grams and all percentages are based upon weight percentages.

Although the embodiments of this disclosure have been disclosed, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

1. A powdered dispersant component for use in chemical coating compositions consisting essentially of an extrudate formed in the presence of water, said extrudate consisting essentially of between 79.3 and 87.2 wt. % triglycidyl isocyanurate (TGIC) polyester, 4.48 to 7.70 wt. % of a polyisocyanate curative, 2.39 to 4.16 wt. % of glass flakes, and a remainder of constituents including at least one of: an anti-corrosion pigment, a UV absorber, a catalyst, a flow modifier, an anti-oxidant, and a degassing agent and wherein all aforementioned wt. % exclude any moisture retained in the extrudate after formation.

2. The powdered dispersant component of claim 1 wherein the remainder of constituents consists essentially of 0.08 to 0.13 wt. % anti-corrosion pigment, 0.40 to 0.70 wt. % UV absorber, 0.16 to 0.28 wt. % catalyst, 0.40 to 0.70 wt. % of flow modifier, 1.58 to 2.78 wt. % antioxidant, 2.94 to 5.12 wt. % degassing agent and wherein all aforementioned wt. % exclude any moisture retained in the extrudate after formation.

3. The powdered dispersant component of claim 1 wherein, by weight, approximately 1 part of water is provided to between 1.85 to 3.00 parts of extrudate during formation of the extrudate and wherein moisture is retained in the extrudate after formation.

4. The powdered dispersant component of claim 1 wherein, after formation and grinding of the extrudate into particles, the dispersant component is provided on a silica carrier.

5. The powdered dispersant component of claim 4 wherein a ratio of silica carrier to dispersant component is provided at between 9:11 and 3:7.

6. The powdered dispersant component of claim 4 wherein the silica carrier is selected from (3-aminopropyl) trimethoxysilane, silicon dioxide, and combinations thereof.

7. The powdered dispersant component of claim 1 wherein the extrudate is provided as particles each having a size of less than 5 micrometers.

8. The powdered dispersant component of claim 7 wherein substantially all of the particles are greater than 100 nanometers.

9. A chemical coating composition comprising:
the dispersant of claim 1; and
a finished coating composition comprising one or more resins and optional additives, wherein each of the one or more resins are chemically distinct from the extrudate and wherein the finished coating composition comprises at least 90% of the total weight of the chemical coating composition.

10. The chemical coating composition of claim 10 wherein the dispersant component is 0.06 to 1.50 wt. % of the total composition with the finished coating resin(s) and optional finished coating additives provided as remainder.

11. The chemical coating composition of claim 10 wherein the optional additives are present and include at least one additive selected from: 12-hydroxy-9-cis-octadecenoic acid, glass flakes, tetramethoxy glycoluril, pigments, waxes, hardening catalysts, and any combination of two or more thereof

12. The chemical coating composition of claim 10 wherein the finished coating composition is provided as particles each being greater than 20 micrometers in diameter.

13. The chemical coating composition of claim 10 wherein the finished coating composition is provided as particles each being less than 40 micrometers in diameter.

14. The chemical coating composition of claim 10 wherein the resin(s) of the finished coating composition include a thermosetting resin.

15. The chemical coating composition of claim 14 wherein the thermosetting resin is selected from the group consisting of epoxy resin, epoxy-polyester resin, acrylic resin, hydroxyl polyester resin, TGIC polyester, TGIC-free polyester resin, acrylic resin and any combination of two or more thereof.

16. The chemical coating composition of claim 14 wherein the thermosetting resin is a TGIC polyester resin.

17. The chemical coating composition of claim 10 wherein the finished coating composition forms a fusion powder coating film when cured.

18. A process of making a dispersant additive for use in finished chemical coating compositions, the process comprising:
preparing a liquid precursor by:
admixing dried constituents to create an admixture, the dried constituents including greater than 75 wt. % (relative to the directed constituents) of triglycidyl isocyanurate (TGIC) polyester resin and a remainder including a polyisocyanate curative, glass flakes, and at least one or more selected from: an anti-corrosion pigment, a UV absorber, a catalyst, a flow modifier, an anti-oxidant, and a degassing agent, and
mixing water with the admixture at a ratio of at least 1 part by weight of water to 3 parts by weight or less of admixture to create an extrusion mixture;
extruding the extrusion mixture to produce a dispersant extrudate; and
grinding the dispersant extrudate to a predetermined particle size range to produce the dispersant additive.

19. The process of claim 18 wherein the dispersant extrudate includes moisture imparted from the mixing of water with the admixture.

20. The process of claim 18 wherein the water is distilled and/or deionized water.

21. The process of claim 18 wherein the ratio is 1 part of water to between 1.85 and 3.00 parts of admixture.

22. The process of claim 18 further comprising, after extruding and grinding, mixing a silica carrier to form the dispersant additive.

23. The process of claim 18 wherein the predetermined particle sizes all fall between 100 nanometers and 5 micrometers in diameter.

24. The process of claim 18 wherein the admixture consists essentially of between 79.3 and 87.2 wt. % triglycidyl isocyanurate (TGIC) polyester, 4.48 to 7.70 wt. % of a polyisocyanate curative, 2.39 to 4.16 wt. % of glass flakes, and a remainder of constituents including at least one of: an anti-corrosion pigment, a UV absorber, a catalyst, a flow modifier, an anti-oxidant, and a degassing agent and wherein all aforementioned wt. % exclude any moisture retained in the extrudate after formation.

25. The process of claim 18 wherein the remainder consists essentially of 4.48 to 7.70 wt. % of a polyisocyanate curative, 2.39 to 4.16 wt. % of glass flakes, 0.08 to 0.13 wt. % anti-corrosion pigment, 0.40 to 0.70 wt. % UV absorber, 0.16 to 0.28 wt. % catalyst, 0.40 to 0.70 wt. % of flow modifier, 1.58 to 2.78 wt. % antioxidant, and 2.94 to 5.12 wt. % degassing agent.
